(19) United States
(12) Patent Application Publication
(10) Pub. No.: US 2025/0368908 A1
(43) Pub. Date: Dec. 4, 2025

(54) BIOMASS GASIFICATION AND CARBON CAPTURE COUPLED SYSTEM AND PROCESS

(71) Applicant: YINGKOU INSTITUTE OF TECHNOLOGY, Yingkou (CN)

(72) Inventors: Wei KOU, Yingkou (CN); Yan ZHOU, Yingkou (CN); Zhaonan SUN, Yingkou (CN); Changguo YAN, Yingkou (CN); Xiaowei LI, Yingkou (CN); Lijie SHAO, Yingkou (CN); Xiaoming WANG, Yingkou (CN); Yujin PAN, Yingkou (CN); Jing WANG, Yingkou (CN)

(73) Assignee: YINGKOU INSTITUTE OF TECHNOLOGY, Yingkou (CN)

(21) Appl. No.: 19/223,075

(22) Filed: May 30, 2025

(30) Foreign Application Priority Data
May 30, 2024 (CN) 202410688771.8

(51) Int. Cl. C10J 3/48; C10J 3/46; C10J 3/82; C10K 1/00; C10K 1/12; C10K 1/20

(52) U.S. Cl. CPC C10J 3/482; C10J 3/463; C10J 3/82; C10K 1/001; C10K 1/005; C10K 1/121; C10K 1/20; C10J 2300/0916; C10J 2300/1612

(57) ABSTRACT

Provided is a biomass gasification and carbon capture coupled system to solve the problem that how to realize efficient utilization of the biomass energy, effective emission reduction of the carbon dioxide (CO₂), and low-cost production of the alkaline compounds. The biomass gasification and carbon capture coupled system includes a fluidized bed device configured to gasify a biomass raw material, where an output end of the fluidized bed device is connected to a pressure swing adsorption (PSA) device; an output end of the PSA device is connected to an ammonia (NH₃) production device; an output end of the NH₃ production device is connected to a carbon capture device; the PSA device is further connected to a heat utilization device; and the heat utilization device is configured to provide heat energy for the NH₃ production device.

### CROSS REFERENCE TO THE RELATED APPLICATIONS

This application is based upon and claims priority to Chinese Patent Application No. 202410688771.8, filed on May 30, 2024, the entire contents of which are incorporated herein by reference.

### TECHNICAL FIELD

The present disclosure relates to the technical field of biomass resource utilization, and in particular to a biomass gasification and carbon capture coupled system and a process.

### BACKGROUND

Biomass refers to various organisms formed using atmosphere, water, soil and the like through photosynthesis. In a narrow sense, it mainly refers to organic matters derived from lignocellulose such as straw and wood, residues in the agricultural product processing industry, agricultural and forestry waste, and animal excrements.

Biomass gasification is a thermochemical process that can convert biomass raw materials into a combustible gas. It can make use of the agricultural and forestry waste, municipal waste and other biomass resources to generate a syngas for power generation, hydrogen (H₂) production, or liquid fuel synthesis, realizing rapid conversion and utilization of biomass waste. Carbon capture from the industrial tail gas is a technology that separates carbon dioxide (CO₂) exhausted in an industrial process from the tail gas for utilization, reducing greenhouse gas emissions and mitigating global warming. As an industrial process that converts sodium- and potassium-containing raw materials into alkaline compounds, alkali production can produce important chemical products such as sodium carbonate, sodium hydroxide, potassium carbonate, and potassium hydroxide.

Exploring an innovative solution integrated with the above three methods will realize efficient utilization of the biomass energy, effective emission reduction of the CO₂, and low-cost production of the alkaline compounds. Therefore, a problem to be solved in industrial carbon capture and utilization (CCU) at present is to make reasonable use of the biomass gasification to generate the syngas, take the syngas as a reductant to react with the CO₂ captured in the industrial tail gas to generate sodium- or potassium-containing alkaline compounds, and release and utilize high-purity H₂, thereby improving the added value of the biomass energy, reducing the energy consumption and cost of the alkali production, and finally realizing resource utilization of the CO₂ and biomass.

### SUMMARY

In order to solve the above problem, namely to realize efficient utilization of the biomass energy, effective emission reduction of the CO₂, and low-cost production of the alkaline compounds, the present disclosure provides a biomass gasification and carbon capture coupled system, including a fluidized bed device configured to gasify a biomass raw material, where an output end of the fluidized bed device is connected to a pressure swing adsorption (PSA) device; an output end of the PSA device is connected to an ammonia (NH₃) production device; an output end of the NH₃ production device is connected to a carbon capture device; the PSA device is further connected to a heat utilization device; and the heat utilization device is configured to provide heat energy for the NH₃ production device.

As a further solution of the present disclosure, a storage device is further connected between the fluidized bed device and the PSA device, so as to store a syngas.

As a further solution of the present disclosure, the NH₃ production device includes a synthesis tower; the synthesis tower includes an input end connected to the PSA device, and an output end connected to a water cooler; an output end of the water cooler is connected to an NH₃ separator, so as to separate other gases from NH₃; and an output end of the NH₃ separator is connected to the carbon capture device.

As a further solution of the present disclosure, the NH₃ separator is further connected to a circulating tube; the other end of the circulating tube is connected to the input end of the synthesis tower; and a circulating compressor is provided on the circulating tube, so as to convey excess nitrogen (N₂) and H₂ in the NH₃ separator to the synthesis tower for recycling.

As a further solution of the present disclosure, the heat utilization device includes a combustion chamber; a burner is provided on the combustion chamber; the PSA device is connected to the burner, so as to convey a combustible gas in the PSA device to the burner; and a heat exchanger is further provided in the combustion chamber, so as to realize heat exchange between the combustion chamber and the NH₃ production device.

As a further solution of the present disclosure, the combustion chamber is connected to the carbon capture device.

The present disclosure further provides a process using the biomass gasification and carbon capture coupled system, including the following steps:
step 1: adding the biomass raw material to the fluidized bed device for gasification to generate the syngas;
step 2: conveying the syngas to the PSA device for PSA to obtain the combustible gas, N₂ and H₂;
step 3: charging the N₂ and the H₂ to the NH₃ production device, charging the combustible gas to the heat utilization device, making the NH₃ production device to reach 400° C. through heat exchange by the heat utilization device, adjusting a pressure in the NH₃ production device to 180 bar, adding an iron-based catalyst, and performing NH₃ synthesis to generate liquid NH₃; and
step 4: charging the liquid NH₃ to the carbon capture device to prepare an alkaline solution.

The present disclosure further provides a process using the biomass gasification and carbon capture coupled system, including the following steps:
step 1: adding the biomass raw material to the fluidized bed device for gasification to generate the syngas;
step 2: conveying the syngas to the PSA device for gas separation to obtain the combustible gas, N₂ and H₂;
step 3: charging the N₂ and the H₂ to the NH₃ production device, charging the combustible gas to the heat utilization device, making the NH₃ production device to reach 400° C. through heat exchange by the heat utilization device, adjusting a pressure in the NH₃ production device to 180 bar, adding an iron-based catalyst, and performing NH₃ synthesis to generate liquid NH₃; and
step 4: charging the liquid NH₃ to the carbon capture device to prepare an alkaline solution.

The present disclosure has the following beneficial effects:
1. With the PSA device for the PSA on the syngas, the present disclosure separates the N₂, the H₂ and the combustible gas from the syngas. In cooperation with the NH₃ production device, the present disclosure synthesizes the liquid NH₃, providing a raw material for the carbon capture process, and further realizing comprehensive utilization of the syngas in the biomass gasification.
2. With the heat utilization device, the present disclosure can make full use of the combustible gas, such that heat generated by the heat utilization device can be applied to the NH₃ production device, realizing efficient utilization and ultra-low emission of biomass resources.

### BRIEF DESCRIPTION OF THE DRAWINGS

FIG. 1 is a schematic structural view according to the present disclosure;

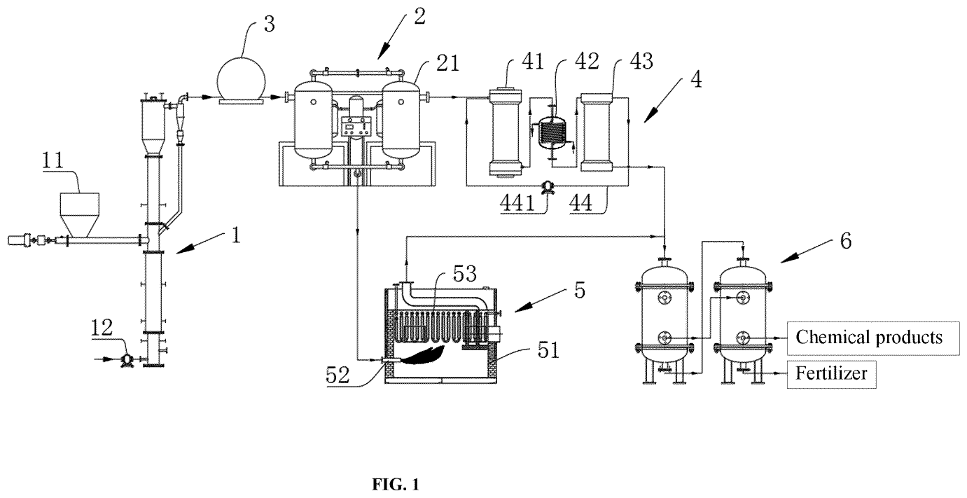

FIG. 2 is a flowchart of a process according to Example 2; and

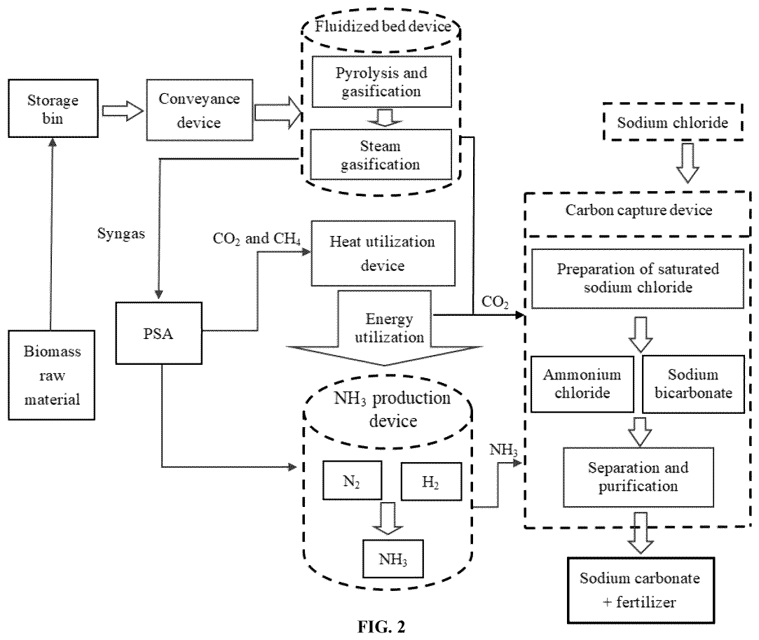

FIG. 3 is a flowchart of a process according to Example 3.

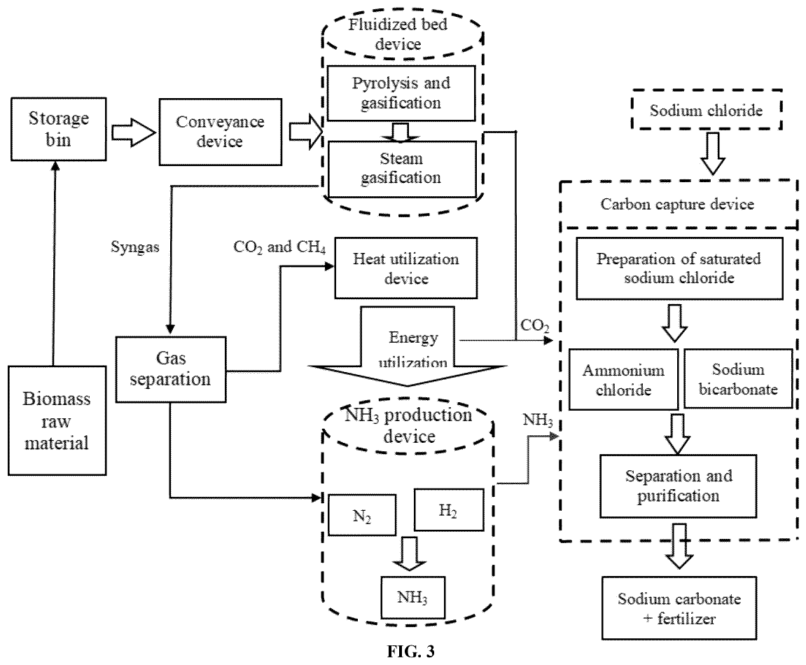

Reference numerals: 1: fluidized bed device, 11: feed bin, 12: blower, 2: PSA device, 21: adsorption tower, 3: storage device, 4: NH₃ production device, 41: synthesis tower, 42: water cooler, 43: NH₃ separator, 44: circulating tube, 441: circulating compressor, 5: heat utilization device, 51: combustion chamber, 52: burner, 53: heat exchanger, and 6: carbon capture device.

### DETAILED DESCRIPTION OF THE EMBODIMENTS

The preferred implementations of the present disclosure are described below with reference to the drawings. Those skilled in the art should understand that the implementations herein are merely intended to explain the technical principles of the present disclosure, rather than to limit the protection scope of the present disclosure.

### Example 1

The present disclosure provides a biomass gasification and carbon capture coupled system, including a fluidized bed device 1 configured to gasify a biomass raw material. The fluidized bed device 1 is a fluidized-bed gasifier. A feed bin 11 is provided on the fluidized bed device 1. The biomass raw material can be filled into the fluidized bed device 1 through the feed bin 11. A blower 12 is further provided at a bottom of the fluidized bed device 1, so as to convey air to a fluidized bed to cool the biomass raw material in the fluidized-bed gasifier.

An output end of the fluidized bed device 1 is connected to a PSA device 2 through a tube. The biomass raw material undergoes gasification in a reactor of the fluidized bed device 1 to generate a syngas, with a reaction formula as follows:

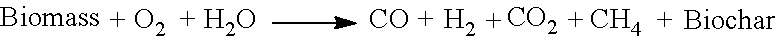

Upon treatment such as detarring, dewatering, and purification, the syngas is conveyed to the PSA device 2.

The PSA device 2 includes two adsorption towers 21. the top end and bottom end of each of the two adsorption towers 21 are connected through a tube. An input end of one adsorption tower 21 is connected to the fluidized bed device 1, and a storage device 3 is further provided on a tube connected to the input end of the adsorption tower and the adsorption tower. The syngas generated by the fluidized bed device 1 is first conveyed to the storage device 3 for storage, and then an appropriate amount of syngas is conveyed to the adsorption tower 21 from the storage device 3 for adsorptive separation.

The syngas enters the adsorption tower 21 for PSA, thereby separating N₂, H₂, CO₂ and a combustible gas. The combustible gas includes carbon monoxide (CO) and methane (CH₄).

An output end of one adsorption tower 21 not directly connected to the fluidized bed device 1 is connected to an NH₃ production device 4. The tube connected to the bottom ends of the two adsorption towers 21 is further connected to a heat utilization device 5, so as to convey the separated combustible gas from the syngas to the heat utilization device 5, providing a fuel for the heat utilization device 5. The heat utilization device 5 is configured to provide heat energy for the NH₃ production device 4, such that a desired temperature for synthesizing NH₃ can be maintained in the NH₃ production device 4.

The heat utilization device 5 includes a combustion chamber 51. A burner 52 is provided on a sidewall of the heat utilization device 51. The burner 52 is connected to the adsorption tower 21, such that the combustible gas is conveyed to the burner 52 and ignited by the burner 52. A heat exchanger 53 is further provided in the combustion chamber 51. The heat exchanger 53 is configured to realize heat exchange between the combustion chamber 51 and the NH₃ production device 4. That is, heat generated by ignition of the burner 52 can be transferred to the NH₃ production device 4 through the burner 52 to maintain a temperature of the NH₃ production device 4.

The NH₃ production device 4 includes a synthesis tower 41. An input end of the synthesis tower 41 is connected to the adsorption tower 21, so as to convey the N₂ and the H₂ separated in the adsorption tower 21 to the synthesis tower 41 to synthesize NH₃. A reaction formula for synthesizing the NH₃ is as follows:

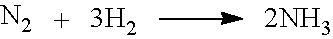

An output end of the synthesis tower 41 is connected to a water cooler 42. Synthetic NH₃ is conveyed to the water cooler 42 from the synthesis tower 41 for cooling. An output end of the water cooler 42 is connected to an NH₃ separator 43, so as to separate other gases from the NH₃. An output end of the NH₃ separator 43 is connected to a carbon capture device 6. The carbon capture device 6 is configured to recycle and convert CO₂, thereby preparing carbonate and an alkaline solution.

The NH₃ separator 43 is further connected to a circulating tube 44. The other end of the circulating tube 44 is connected to the input end of the synthesis tower 41. A circulating compressor 441 is provided on the circulating tube 44, so as to convey excess N₂ and H₂ in the NH₃ separator to the synthesis tower 41 for recycling.

It is to be noted that CO₂ separated in the adsorption tower 21 and CO₂ generated by combustion in the combustion chamber 51 are conveyed to the carbon capture device 6 to serve as one of raw materials in a carbon capture process.

### Example 2

The present disclosure provides a process using the biomass gasification and carbon capture coupled system in Example 1, including the following steps:
Step 1: The biomass raw material was added to the fluidized bed device 1 for the gasification to generate the syngas. Step 2: The syngas was conveyed to the PSA device 2 for the PSA to obtain the combustible gas, the CO₂, the N₂ and the H₂.
Step 3: The N₂ and the H₂ were charged to the NH₃ production device 4, the combustible gas was charged to the heat utilization device 5, the NH₃ production device 4 reached 400° C. through heat exchange by the heat utilization device 5, a pressure in the NH₃ production device 4 was adjusted to 180 bar, an iron-based catalyst was added, and NH₃ synthesis was performed to generate liquid NH₃.
Step 4: The liquid NH₃ was charged to the carbon capture device 6 to prepare the alkaline solution.

In Step 1, the gasification is performed at a temperature of 850° C. with the addition of a gasifying agent. The gasifying agent is air or oxygen, and the gasification reaction formula is as follows:

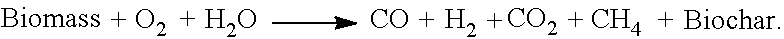

In Step 2, the PSA has an adsorption pressure of 8 bar, and a desorption pressure of 0.1-0.5 bar.

It is to be noted that the PSA is a cyclic process that utilizes different adsorption capacities of molecular sieves for different molecules to realize adsorption and desorption at different pressures. The PSA in the present disclosure is the prior art, and is not repeatedly described herein.

In Step 3, the combustion temperature of the combustible gas in the heat utilization device 5 is 1000° C. It is to be noted that the combustion temperature may fluctuate, and the combustion process requires the addition of a combustion agent. The combustion agent is water vapor and air. The reaction formula for synthesizing the NH₃ is as follows:

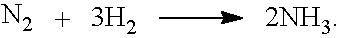

The carbon capture in Step 4 is the prior art, and is not repeatedly described herein.

In the example, the syngas includes the following components: 20.5% of CO, 18.2% of H₂, 8.6% of CH₄, 15.3% of CO₂, and 37.4% of N₂. Upon the PSA on the syngas, the H₂ has a purity of 99.9%, and the N₂ has a purity of 99.8%. Upon the combustion on the syngas, the CO₂ has a purity of 99.5%. The conversion rate in the NH₃ synthesis is 85.6%.

The conversion rate in the NH₃ synthesis is calculated by:

$$\frac{( {F}_{H 2 in} - {F}_{H 2 out} )}{{F}_{H 2 in \times 100 \%}}$$

F_{H2 in} is a flow of H₂ at the input end of the synthesis tower 41, and F_{H2 out} is a flow of H₂ at the output end of the synthesis tower 41.

### Example 3

The present disclosure provides a process using the biomass gasification and carbon capture coupled system in Example 1, including the following steps:
Step 1: The biomass raw material was added to the fluidized bed device 1 for the gasification to generate the syngas. Step 2: The syngas was conveyed to the PSA device 2 for gas separation to obtain the combustible gas, the N₂ and the H₂.
Step 3: The N₂ and the H₂ were charged to the NH₃ production device 4, the combustible gas was charged to the heat utilization device 5, the NH₃ production device 4 reached 400° C. heat exchange by the heat utilization device 5, a pressure in the NH₃ production device 4 was adjusted to 180 bar, an iron-based catalyst was added, and NH₃ synthesis was performed to generate liquid NH₃.
Step 4: The liquid NH₃ was charged to the carbon capture device 6 to prepare the alkaline solution.

In Step 1, the gasification is performed at a temperature of 850° C. with the addition of a gasifying agent. The gasifying agent is air or oxygen, and the gasification reaction formula is as follows:

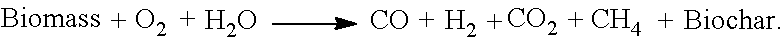

In Step 2, the gas separation makes use of selective permeability of a semipermeable membrane to separate gas based on different molecular sizes or solubilities. It is applied to gas separation in specific conditions, with efficiency and selectivity depending on a membrane material and operating parameters. The gas separation in the present disclosure is the prior art, and is not repeatedly described herein.

In Step 3, the combustion temperature of the combustible gas in the heat utilization device 5 is 1000° C. It is to be noted that the combustion temperature may fluctuate, and the combustion process requires the addition of a combustion agent. The combustion agent is water vapor and air. The reaction formula for synthesizing the NH₃ is as follows:

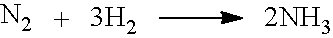

The carbon capture in Step 4 is the prior art, and is not repeatedly described herein.

In the example, the syngas includes the following components: 18.7% of CO, 20.1% of H₂, 9.4% of CH₄, 14.2% of CO₂, and 37.6% of N₂. Upon the gas separation on the syngas, the H₂ has a purity of 99.8%, and the N₂ has a purity of 99.7%. Upon the combustion on the syngas, the CO₂ has a purity of 99.6%. The conversion rate in the NH₃ synthesis is 86.2%.

The conversion rate in the NH₃ synthesis is calculated by:

$$\frac{( {F}_{H 2 in} - {F}_{H 2 out} )}{{F}_{H 2 in \times 100 \%}}$$

F_{H2 in} is a flow of H₂ at the input end of the synthesis tower 41, and F_{H2 out} is a flow of H₂ at the output end of the synthesis tower 41.

In conclusion, with the PSA device 2 for the PSA on the syngas, the present disclosure separates the N₂, the H₂ and the combustible gas from the syngas. In cooperation with the NH₃ production device 4, the present disclosure synthesizes the liquid NH₃, providing a raw material for the carbon capture process, and further realizing comprehensive utilization of the syngas in the biomass gasification. With the heat utilization device 5, the present disclosure can make full use of the combustible gas, such that heat generated by the heat utilization device 5 can be applied to the NH₃ production device 4, realizing efficient utilization and ultra-low emission of biomass resources.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A biomass gasification and carbon capture coupled system, comprising a fluidized bed device configured to gasify a biomass raw material, wherein an output end of the fluidized bed device is connected to a pressure swing adsorption (PSA) device; an output end of the PSA device is connected to an ammonia (NH₃) production device; an output end of the NH₃ production device is connected to a carbon capture device; the PSA device is further connected to a heat utilization device; and the heat utilization device is configured to provide heat energy for the NH₃ production device.

2. The biomass gasification and carbon capture coupled system according to claim 1, wherein a storage device is further connected between the fluidized bed device and the PSA device, so as to store a syngas.

3. The biomass gasification and carbon capture coupled system according to claim 1, wherein the NH₃ production device comprises a synthesis tower; the synthesis tower comprises an input end connected to the PSA device, and an output end connected to a water cooler; an output end of the water cooler is connected to an NH₃ separator, so as to separate other gases from NH₃; and an output end of the NH₃ separator is connected to the carbon capture device.

4. The biomass gasification and carbon capture coupled system according to claim 3, wherein the NH₃ separator is further connected to a first end of a circulating tube; a second end of the circulating tube is connected to the input end of the synthesis tower; and a circulating compressor is provided on the circulating tube, so as to convey excess nitrogen (N₂) and hydrogen (H₂) in the NH₃ separator to the synthesis tower for recycling.

5. The biomass gasification and carbon capture coupled system according to claim 1, wherein the heat utilization device comprises a combustion chamber; a burner is provided on the combustion chamber; the PSA device is connected to the burner, so as to convey a combustible gas in the PSA device to the burner; and a heat exchanger is further provided in the combustion chamber, so as to realize heat exchange between the combustion chamber and the NH₃ production device.

6. The biomass gasification and carbon capture coupled system according to claim 5, wherein the combustion chamber is connected to the carbon capture device.

7. A process using the biomass gasification and carbon capture coupled system according to claim 1, comprising the following steps:
step 1: adding the biomass raw material to the fluidized bed device for gasification to generate a syngas;
step 2: conveying the syngas to the PSA device for PSA to obtain a combustible gas, N₂, and H₂;
step 3: charging the N₂ and the H₂ to the NH₃ production device, charging the combustible gas to the heat utilization device, making the NH₃ production device reach 400° C. through heat exchange by the heat utilization device, adjusting a pressure in the NH₃ production device to 180 bar, adding an iron-based catalyst, and performing NH₃ synthesis to generate liquid NH₃; and
step 4: charging the liquid NH₃ to the carbon capture device to prepare an alkaline solution.

8. A process using the biomass gasification and carbon capture coupled system according to claim 1, comprising the following steps:
step 1: adding the biomass raw material to the fluidized bed device for gasification to generate a syngas;
step 2: conveying the syngas to the PSA device for gas separation to obtain a combustible gas, N₂, and H₂;
step 3: charging the N₂ and the H₂ to the NH₃ production device, charging the combustible gas to the heat utilization device, making the NH₃ production device reach 400° C. through heat exchange by the heat utilization device, adjusting a pressure in the NH₃ production device to 180 bar, adding an iron-based catalyst, and performing NH₃ synthesis to generate liquid NH₃; and
step 4: charging the liquid NH₃ to the carbon capture device to prepare an alkaline solution.

9. The process using the biomass gasification and carbon capture coupled system according to claim 7, wherein in the biomass gasification and carbon capture coupled system, a storage device is further connected between the fluidized bed device and the PSA device, so as to store the syngas.

10. The process using the biomass gasification and carbon capture coupled system according to claim 7, wherein in the biomass gasification and carbon capture coupled system, the NH₃ production device comprises a synthesis tower; the synthesis tower comprises an input end connected to the PSA device, and an output end connected to a water cooler; an output end of the water cooler is connected to an NH₃ separator, so as to separate other gases from NH₃; and an output end of the NH₃ separator is connected to the carbon capture device.

11. The process using the biomass gasification and carbon capture coupled system according to claim 10, wherein in the biomass gasification and carbon capture coupled system, the NH₃ separator is further connected to a first end of a circulating tube; a second end of the circulating tube is connected to the input end of the synthesis tower; and a circulating compressor is provided on the circulating tube, so as to convey excess N₂ and H₂ in the NH₃ separator to the synthesis tower for recycling.

12. The process using the biomass gasification and carbon capture coupled system according to claim 7, wherein in the biomass gasification and carbon capture coupled system, the heat utilization device comprises a combustion chamber; a burner is provided on the combustion chamber; the PSA device is connected to the burner, so as to convey the combustible gas in the PSA device to the burner; and a heat exchanger is further provided in the combustion chamber, so as to realize heat exchange between the combustion chamber and the NH₃ production device.

13. The process using the biomass gasification and carbon capture coupled system according to claim 12, wherein in the biomass gasification and carbon capture coupled system, the combustion chamber is connected to the carbon capture device.

14. The process using the biomass gasification and carbon capture coupled system according to claim 8, wherein in the biomass gasification and carbon capture coupled system, a storage device is further connected between the fluidized bed device and the PSA device, so as to store the syngas.

15. The process using the biomass gasification and carbon capture coupled system according to claim 8, wherein in the biomass gasification and carbon capture coupled system, the NH₃ production device comprises a synthesis tower; the synthesis tower comprises an input end connected to the PSA device, and an output end connected to a water cooler; an output end of the water cooler is connected to an NH₃ separator, so as to separate other gases from NH₃; and an output end of the NH₃ separator is connected to the carbon capture device.

16. The process using the biomass gasification and carbon capture coupled system according to claim 15, wherein in the biomass gasification and carbon capture coupled system, the NH₃ separator is further connected to a first end of a circulating tube; a second end of the circulating tube is connected to the input end of the synthesis tower; and a circulating compressor is provided on the circulating tube, so as to convey excess N₂ and H₂ in the NH₃ separator to the synthesis tower for recycling.

17. The process using the biomass gasification and carbon capture coupled system according to claim 8, wherein in the biomass gasification and carbon capture coupled system, the heat utilization device comprises a combustion chamber; a burner is provided on the combustion chamber; the PSA device is connected to the burner, so as to convey the combustible gas in the PSA device to the burner; and a heat exchanger is further provided in the combustion chamber, so as to realize heat exchange between the combustion chamber and the NH₃ production device.

18. The process using the biomass gasification and carbon capture coupled system according to claim 17, wherein in the biomass gasification and carbon capture coupled system, the combustion chamber is connected to the carbon capture device.
